(19) United States
(12) Patent Application Publication
(10) Pub. No.: US 2020/0156959 A1
(43) Pub. Date: May 21, 2020

(54) METHOD OF ACCELERATING EVAPORATION OF WATER AND DEVICE FOR ITS IMPLEMENTATION

(71) Applicant: Oleg Yurevich Nikolaev, Moscow (RU)

(72) Inventors: Oleg Yurevich NIKOLAEV, Moscow (RU); Nikolai Sergeevich VASILKOV, Moscow (RU); Vladimir Aleksandrovich SPITSIN, g. Dolgoprudnyi (RU)

(21) Appl. No.: 16/686,907

(22) Filed: Nov. 18, 2019

(30) Foreign Application Priority Data
Nov. 18, 2018 (RU) 2018140408

(51) Int. Cl. C02F 1/14; B01D 1/00; B01D 1/30

(52) U.S. Cl. CPC C02F 1/14; B01D 1/30; B01D 1/0005; B01D 1/0035

(57) ABSTRACT

The invention relates to a method and device for accelerating the evaporation of liquids, in particular water, using solar energy. The device is made of a polymer material with a density of 0.8-0.95 g/cm³ and contains a flat base, on the upper and lower surfaces of which there are ribs to ensure that the surface of the base is immersed under the surface of water, while the ratio the mass of the upper, lower ribs and base is 1:1:1. The efficiency of water evaporation is increased due to solar energy absorption into the thin surface layer of water having a thickness from 1 to 10 mm. The method uses the fact that the thin surface layer of water is isolated while the device under the surface of water. As the surface layer evaporates the device is steadily positioned at a given depth below the water surface.

### FIELD OF INVENTION

The invention is related to a method and apparatus for accelerating the evaporation of liquids, in particular, water, using solar energy.

### BACKGROUND

The prior art device (pond-evaporator) for the evaporation of wastewater of various genesis. The evaporation pond is interfaced by means of water control structures with a supply channel and is equipped with floating evaporating elements of a hydrophilic capillary-porous material. Floating evaporating elements are made in the form of hollow perforated drums coated with hydrophilic capillary-porous material, fixed between two supporting floats with the possibility of rotation around their horizontal axis with the help of end axles inserted into the bushings placed along the length of the floats. The drums are equipped with a mechanism for their simultaneous rotation of 180° and vice versa (RF patent No. 2527041, Aug. 27, 2014).

The disadvantage of this device is the need to clean the evaporating elements from salt deposits, which leads to an increase in the complexity of the evaporation method using this device. At the same time, poor-quality cleaning of the evaporating elements leads to a decrease in the efficiency of liquid evaporation by reducing the area of the evaporating surface.

Other disadvantages of the device are the complexity of its design and the bulkiness of the device.

### SUMMARY

The technical problem to be solved by the claimed group of inventions is to develop a simple device and method for efficient and rapid evaporation of water.

The technical result achieved by the implementation of the claimed group of inventions is the simplicity of installation and operation of the device due to the small size of the device, reducing the complexity of the operation of the device and method of evaporation of water due to the absence of the need to remove salt deposits from the surface of the device for evaporation, eliminating labor costs for installing the device in the working position, immersion and balancing of the device under the surface layer of water during operation of the device, as well as the growth of the design of the device for water evaporation, increasing the operational characteristics of the device, which is achieved by increasing the reliability of the device, as well as the increased efficiency of water evaporation due to the concentration of solar energy in the thin surface water layer, eliminating the salt deposits formation on the surface of the device.

The specified technical result is achieved through the use of a novel device for accelerating the water evaporation; the device is made of a polymer material with a density of 0.8-0.95 g/cm³ and containing a flat base, on the upper and lower surfaces of which a number of ribs are placed to ensure immersion of the surface of the base of the device under the surface layer of water, while the ratio of the mass of the upper, lower ribs and base is 1:1:1.

The technical result is also achieved due to the implementation of the method of accelerating the evaporation of water, which consists in isolating the thin surface layer of water by placing the device under the surface layer of water, the heat absorbed by the base of the device is transferred to the thin surface layer of water to stimulate evaporation, as the surface layer of water evaporates, the device is steadily positioned at a predetermined level below the surface of the water.

The base of the device can be made in the form of hexagonal tiles, which contributes to the compact self-organization of a group of tiles to increase the evaporation area. The device is completely symmetrical and does not require orientation when laying out on water.

The device can be made of polymeric materials that are resistant to thermal and ultraviolet radiation, for example, polyethylene.

The device can be made of polymeric materials that are unstable to thermal and ultraviolet radiation and water (degradable).

The implementation of the device from degradable materials provides control over the life of the devices and the absence of the need for their disposal after the expiration of their use. Devices can be made of materials that undergo decomposition after 1-3 years.

The ribs on the upper and lower sides of the base can be made triangular in shape.

The device is placed under the surface layer of water with a thickness of 1-10 mm. The maximum efficiency of the device is achieved with the smallest depth of immersion under the surface of water, for example, 1-5 mm.

The implementation of the device from a polymer material with a density of 0.8-0.95 g/cm³ in the form of a flat base, on the upper and lower surfaces of which there are ribs with a ratio of the mass of the upper, lower ribs and the base 1:1:1 ensures the achievement of hydrostatic equilibrium when immersed the surface of the base of the device under the surface layer of water with a thickness of 1-10 mm. That is, the gravity acting on the device is balanced by buoyancy when the base is completely submerged by 1-10 mm.

Moreover, the design of the device (including the mass ratio of structural elements and the choice of density of the material of the device) ensures hydrostatic equilibrium when up to 5% of the mass of the device (up to 15% of the volume of the upper ribs) remains above the surface of the water, that is, when the device is immersed on 95% under water.

Thus, when using the developed device, immersion of the surface of the base of the device under the surface layer of water of 1-10 mm is achieved.

Thus, when placing the device on the surface of the water, isolation of a thin surface layer (1-10 mm or 1-5 mm) of the liquid and stable preservation of the thickness of the insulated layer during operation of the device is achieved, thus, during the heating of the base surface of the device by the sun's rays and transfer of the received heat to the surface layer, there is no periodic change in the thickness of the insulated layer, the layer thickness is maintained throughout the entire process, as a result of which the heating of water accelerates and therefore the evaporation accelerates.

The ability to isolate a thin layer of water and maintain it at the same level provides a stable heating rate and, accordingly, a stable evaporation rate, which allows to increase the reliability of the device and increase the operational characteristics of the device as a whole.

In addition, the location and retention of the base of the device under a water layer of 1-10 mm allows for effective evaporation with heating of the water that does not exceed the temperature of precipitation and deposition of salts on the tile (for example, 55° C. for calcium carbonate). Thus, due to the elimination of the formation of deposits of salts on the surface of the device, there is no need to clean the device, which reduces the complexity during operation of the device. In addition, due to the absence of deposits on the insulating surface of the base, its maximum heating under the influence of sunlight is ensured, which also contributes to the rapid heating of the liquid, effective evaporation and reliable stable operation of the device.

As the liquid evaporates from an isolated surface layer, the device automatically and reliably positioned under the liquid surface at a predetermined initial level. This is due to the fact that in the process of evaporation of the liquid, it is replenished from the periphery of the device. The ability to automatically keep the device under a thin layer of liquid is due to the fact that the device is made of a material characterized by a density of 0.8-0.95 g/cm³, and the ribs (balancing ribs) on the upper and lower surfaces of the base of the device shift the hydrostatic equilibrium of the device due to its mass so that the base is always under the surface layer of a liquid of 1-10 mm or 1-5 mm. Thus, the ribs resist the buoyancy force to balance, stabilize and hold the device at a given depth. The result is a reduction in the complexity during operation of the device and the method itself, since there is no need to immerse and hold the device at the same level under a given water layer by the user.

The ribs are located on the upper and lower surfaces of the base in the direction from the top of each corner of the device to its center. Forming the ribs on both the upper and the lower surfaces of the base is important, since such an arrangement of the ribs helps to stabilize and balance the device under water, which allows isolating a layer of water of a certain thickness and ensures stable preservation of the thickness of the insulated layer during operation of the device. The layer thickness is maintained throughout the entire process of the device operation, resulting in an acceleration of heating of the surface layer of water; the heating being transmitted to water from the base of the device. As a result, an increase in the efficiency of water evaporation by the device is achieved.

Thus, a symmetrical arrangement of the ribs and, accordingly, a uniform distribution of the load is achieved on the surface of the device, which ensures uniform immersion of the device under the surface water layer while maintaining the thickness of the insulated layer and its balancing. It also provides a stable heating rate and, accordingly, a stable rate of water evaporation.

The device can be made in black color for better absorption of sunlight. In addition, the surface of the device may have a developed texture (for example, rough) to increase the absorption capacity. The implementation of the device in black with a developed surface texture provides accelerated heating of the liquid and, thus, an additional increase in the efficiency of evaporation.

The base of the device may have an internal cavity with a height of 3-5 mm, filled with water, acting as an insulating layer, which reduces the diffusion of heat into the mass of water under the device. Thus, it is possible to ensure the transfer of most of the heat obtained by the tile into the insulated surface layer of water and to eliminate heat loss in the deeper water. The implementation of the device with an internal cavity additionally allows for the efficiency of liquid evaporation due to a larger increase in the temperature of the surface layer of the liquid accelerating its evaporation.

The devices have a simple design, which allows without preparatory operations to place one or more tiles on the surface of the reservoir. For full coverage, the appropriate number of tiles are immersed in the pond. Having a hexagonal shape, the tiles are distributed on the surface of the water without gaps between them and form a continuous insulating layer (the tiles are not evaporating surfaces, therefore there are no deposits on them) to separate a thin surface layer of liquid. Ribs prevent the mutual overlapping of devices (tiles) and contribute to their proper organization. As a result, the liquid evaporates from the surface of a thin insulated layer. In addition, the implementation of the device with ribs on the upper and lower surface of the base also allows to reduce the labor costs for installing the tile in the working position, as would be required when the ribs were made on only one surface of the base and the need to install the device with the ribs down to achieve immersion of the base under surface layer of water at a given level.

As the liquid evaporates from an isolated surface layer, the device base is automatically held under the liquid surface at a given level. Thus, fluid replenishment occurs from the periphery of the device, due to the difference in the densities of the liquid and the device. The ability to automatically keep the device at a predetermined level is due to the achievement of hydrostatic equilibrium when the device is immersed in water by 95%, which is ensured by the device design, in particular, the density of the device, as well as the presence on the upper and lower surfaces of the ribs (balancing ribs) with the ratio of the mass of the ribs to mass base 1:1:1. The result is a reduction in the complexity of the operation of the device and the method itself due to the absence of the need to immerse the device by the user.

### BRIEF DESCRIPTION OF THE DRAWINGS

The invention is illustrated by FIGS. 1-4.

FIG. 1 shows the device (top view).

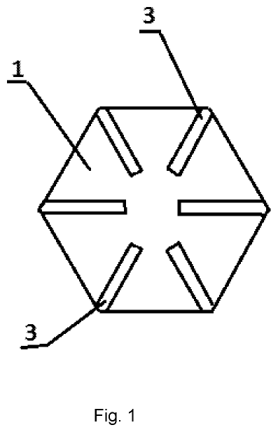

FIG. 2 shows a device immersed under the surface layer of water (side view).

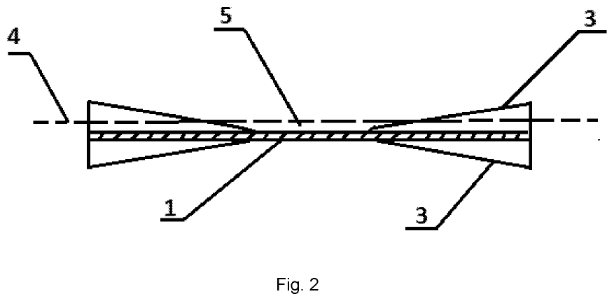

FIG. 3 shows a device whose base has an internal cavity filled with water, immersed under the surface layer of water (side view).

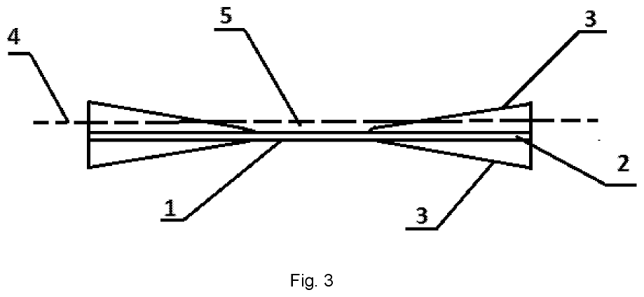

FIG. 4 shows a group of devices distributed over the surface of a reservoir.

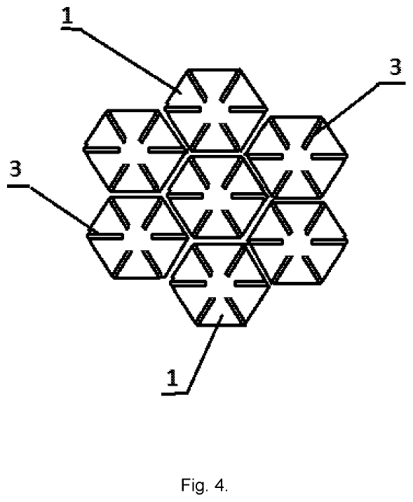

In the figures, positions 1-5 are indicated:
1—the base of the device,
2—internal cavity,
3—ribs
4—the surface of the water,
5—an isolated layer of water.

### DETAILED DESCRIPTION OF THE PREFERRED EMBODIMENT

The device is made in the form of a hexagonal base 1 of black color from low pressure polyethylene with a density of 0.95 g/cm³ and a mass of 30 g with an internal cavity 2 filled with water and ribs of a triangular shape located on the upper and lower surface of the base 3. The height of the ribs on the surface of the base is 10 mm with a total device height of 21 mm, and the total mass of the ribs (upper and lower) is 20 g.

The device is placed on the surface of the water 4. At the same time, the surface of the base of the device is submerged 95% of its volume under the surface of the water to a depth of 1-10 mm, due to a flotation of the device provided by the mass of the device and its design, including the location of the ribs relative to the base. The positive buoyancy of the device is partially compensated by the mass of ribs located above the water level so that the base of the device is always under a layer of water of a given thickness, thereby isolating the surface layer of water. The sun's rays penetrate the insulated layer of water 5, and under their influence the base of the device heats up. The internal cavity of the base prevents the diffusion of heat into the deep water. Most of the heat received by the device is transferred to the surface layer of water, helping to increase its temperature, increase the pressure of saturated vapors on the surface of the liquid, thus leading to evaporation of the liquid from the surface of the insulated layer. As water evaporates from the surface layer, it is replenished from the periphery of the device, due to the difference in the densities of water and the device (given the buoyancy of the device).

The given example is a special case and does not exhaust all possible implementations of the group of inventions.

What is claimed is:

1. A method of accelerating an evaporation of water, wherein a surface layer of water is isolated by placing a device for accelerating the evaporation of water under the surface layer of water, while a heat absorbed by a base of the device is transferred to the surface water layer to stimulate evaporation, and as the surface water layer evaporates, the device is stably placed at a predetermined level below a surface of the water, wherein the base of the device has ribs on an upper and a lower surfaces; the base being made of a polymer material with a density of 0.8-0.95 g/cm³, wherein a mass ratio of the upper, the lower ribs and the base is 1:1:1.

2. The method according to claim 1, wherein the surface layer of water has a thickness of 1-10 mm.

3. A device for accelerating evaporation of water, comprising:
a flat base, having ribs on an upper and a lower surfaces, the base being made of a polymer material with a density of 0.8-0.95 g/cm³, wherein a mass ratio of the upper, the lower ribs and the base is 1:1:1.

4. The device according to claim 3, wherein the base has a developed texture.

5. The device according to claim 4, wherein the developed texture is a rough structure.

6. The device according to claim 3, the device is black.

7. The device according to claim 3, wherein the base additionally has an internal cavity of 3-5 mm deep, the cavity is filled with water.

8. The device according to claim 3, wherein a presence of the ribs on the device ensures facilitates its immersion under a surface layer of water with a thickness of 1-10 mm.
